(19) United States
(12) Patent Application Publication
(10) Pub. No.: US 2006/0059014 A1
(43) Pub. Date: Mar. 16, 2006

(54) Interactive system for confirming the sexual health status of an individual

(76) Inventor: Eli Dancy, Brooklyn, NY (US)

Correspondence Address: GREENBERG & LIEBERMAN, LLC, 2141 WISCONSIN AVE, N.W., SUITE C-2, WASHINGTON, DC, 20007, US

(21) Appl. No.: 10/940,224

(22) Filed: Sep. 14, 2004

(51) Int. Cl. G06Q 10/00

(52) U.S. Cl. 705/2

(57) ABSTRACT

An interactive system for exchanging information about an individual's sexual health status and method for confirming sexual health status of individuals. Basically the system involves means for registering and storing an individual's sexual health status along with his/her personal identity and means for online access to an individual's sexual health status based on said individual's personal identity to ascertain whether the particular individual is STD free or not. Also disclosed is a method for confirming the sexual health status of an individual involving the steps of (a) inputting and recording after proper registration procedures the (b) personal identification; and (c) on-line access to interested persons to the information recorded on an individual's sexual health status on proper submission of personal identification. The system and method would provide for safe guarding the interest of persons free of such diseases to continue to live a safe and healthy life. People can be made more conscious about the needs and purposes of checking of sexual health status without the complexity of delay and time involved in carrying out instant tests. The society at large can benefit by way of having a non-public yet confirmatory source for confirming individual's sexual status.

### FIELD OF THE INVENTION

The present invention relates to an interactive system for exchanging information about an individual's sexual health status and method for confirming sexual health status of individuals. The invention is directed to serve in the prevention of sexually transmitted diseases (STD) and therefore provide for protecting the health of individuals for a safe and healthier living. More specifically the invention will favor controlling widely prevailing sexually transmitted diseases by providing for online and instant sexual health status check of individuals to avoid presently unknown dangers of contacting such widely prevalent diseases.

### BACKGROUND ART

The complexities of modern day living and the fast lifestyle that individuals have to keep pace with has necessitated the provision for regular health care of individuals. For the purpose of such effective health management various systems and methods have been proposed to generate information about an individual's health and favor greater awareness of health considerations of individuals and their healthy living.

JP 03085137A, published Apr. 10, 1991, discloses an apparatus for collection and allocation of health diagnosis data by carrying out indication and printing of schedule and finish of diagnosis so as to make management of diagnosis cards easy by setting up a schedule flag and a finish flag at every health diagnosis item in a health diagnosis data and by indicating and printing whether the diagnosis is scheduled or not and finished or not for every item.

JP 0502816A, published Jul. 22, 1991, provides for a system to prevent the health management system from being used illegally and to allow a user to control the system even when he loses consciousness by inputting personal identification information such as a fingerprint, handprint and a voice print other than an ID card and a pass word.

JP 2001134700A, published Nov. 9, 1999, teaches a system to reduce the job burden of a person engaged in medical treatment for faster management of medical records.

JP 2001321344A, published May 12, 2000, discloses a health control data recording device capable of reducing the work load of the measurement to make measurements at faster rate.

JP 2001344344A, published May 31, 2000, discloses a finger print databased identification for retrieval of individual health information. JP 2002183316A, published Dec. 12, 2000, provides a portable health medical information terminal for personal health medical information.

US2003/0182161A1, published Sep. 25, 2003, discloses an interactive system for providing information and optimizing the service in the health areas and those related thereto able to organize and provide, in an interactive way, information and instructional matters of interest to user (patients/clients) involving an interactive software. The system is adapted to assist the professional in his/her consultation in a substantially interactive process, thus improving the rates of feedback acceptance and respect to the proposed treatments or surgeries, also providing spaces for disclosing products, services and researches that aim at generating a greater interest and benefits.

WO 98/18106A1, published Apr. 30, 1998, concerns a method for producing a personalized user identification document which cannot be forged, authorizing the use of a facility controlled by an authority, said identification document consisting of a card comprising a surface with the photograph of the user, and a memory medium comprising use-related data. The disclosure is useful for producing subscriber cards for public transport, medical identity cards called health cards bankcards.

It would be apparent from the above that information concerning an individual's health is important for effective health management and for assessing the individual's health conditions. Such information on individual's health and system providing for the same are mostly based on needs for treating of an individual, preventing unauthorized recording and use of health information, faster measurement of a patients health condition and portable health condition measuring equipment for ready and immediate use.

U.S. Pat. No. 5,832,447, issued to Edward C. Rieker on Nov. 3, 1998, discloses a method of automatic verifying patient health insurance information using a patients health insurance verification computer system operatively connected to the existing computerized health care system. The discloser is directed for health insurance information in a more reliably manner without human intervention.

The above state-of-art revels the diverse needs of health information and variety of systems and methods developed to suit the specific end uses/application of such human health information. Importantly, one of the most prevalent and widely spreading health concerns affecting people of all walks of life due to the fast changing social needs and the challenging present day lifestyle are the diseases which are sexually transmitted. The recent spread of AIDS/HIV related sexually transmitted diseases have made it extremely difficult to stay free of such deadly diseases in such fast and challenging modern day lifestyle of individuals.

While several health information for medical purpose, diagnostic or verification of insurance details are available none of such systems or methods presently available serve for the much required on-line sexual health status of individuals so that unknown dangers and risks of sexually transmitted diseases could be arrested or at least avoided. While certainly variety of tests are known to know about an individual's state of carrying any sexually transmitted diseases is available to the art none of such system presently serve in benefit utilization of such sexual health status information to prevent spread of sexually transmitted diseases and thereby safe guard an individual's health and the society at large.

### SUMMARY OF THE INVENTION

It is thus the basic object of the present invention to provide for system and method of effective utilization of the sexual health status of individuals and thereby provide for safe guarding the interest of persons free of such diseases to continue to live a safe and healthy life.

Another object of the present invention is directed to prevent or at least reduce chances of sexually transmitted diseases by providing for system and method for confirming individual's sex status by any interested person.

Another object of the present invention is to provide for the system and the method were by the individuals/every person can be made more conscious about the needs and purposes of checking of sexual health status without the complexity of delay and time involved in carrying out instant tests.

Further object of the present invention is directed to generated awareness on the need of the sexual health status of individuals in the form of an authentic identity card based STD free status for individuals not affected by any such disease.

Yet further object is directed to provide the system, which would enable regular and systemized maintenance of health status of individuals so that the society of large can benefit by way of having a non-public yet confirmatory source for confirming individual's sexual status.

Yet further object of the present invention is directed to provide interactive system for confirming the sexual health system and also to a method for online and instant verification of an individual's sex status.

Thus according to the basic aspect of the present invention there is provided an interactive system for confirming the sexual health status of an individual comprising:
means for registering and storing an individual's sexual health status along with his/her personal identity;
means for online access to an individual's sexual health status based on said individual's personal identity to ascertain whether the particular individual is STD free or not.

The interactive system involves personal identity through an individual's ID card and a personal pass code.

The means for registering and storing an individual's sexual health status is a computerized registration system. In particular, the information is stored in a database on health status of individuals and a multimedia means is provided for accessing the information concerning an individual's sexual health. The information subject to ID verification can be by way of interactive voice based sexual health status transmission. The information supplied should also preferably indicate the date of test and the period of validity of the information.

It is thus possible by way of above disclosed interactive system on sexual health identification to provide for an authorized and authenticated system whereby individual interested in safe lifestyle ensure that they do not unknowingly encounter occasion to inherit sexually transmitted diseases.

The system would involve a very simple registration procedure whereby interested individuals can get their sexual health conditions issued by authorized medical practitioners stored. In order to avoid any future complexity on such available sexual health information the registered person can be required to sign release Form entitling the system owner/service provider to allow such information to be accessed by the other registered members. The information of such registered member can be effectively compiled, recorded in a database for a set period of time for the stated members/individuals depending upon the last date of test and the period of validity of such report.

To facilitate the effective exchange of information ID card with Password may be issued to registered members/users of the system. Preferably, personalized user identification document, which cannot be forged, may be issued to ensure greater safety and authenticity in the information obtained using the system.

In accordance with another aspect of the present invention there is provided a method for on-line and instant verification for an individual's sexual health status comprising:
(i) inputting and recording after proper registration procedures the computerized sexual health status of an individual;
(ii) providing the individuals whose sexual records are thus recorded with a personal identification; and
(iii) providing on-line access to interested persons to the information recorded on an individual's sexual health status on proper submission of personal identification number of the concerned individual whose sexual status is being enquired for said on-line verification of the individuals sexual health status.

The above method for on-line verification for an individual's sexual health status is carried out based on the personal identification by way of an ID Card and personal pass code issued to an individual whose sexual health status is recorded.

In accordance with an aspect the said on-line access is allowed subject to proper identification and pass code and payment of requisite fees.

The sexual health status issued is accompanied with the date of last check-up and period of validity of the individual's recorded sexual health concerned. For the purpose a person wanting to enter his/her sexual health status has to undertake full STD screening and then registered. The registration is subject to the individual's offer to release the sexual health status information in said computerized system.

It would be further apparent that the above method for online and instance verification of an individual's sexual health status is simple and can be readily used by any ordinary person without need for specialized knowledge/skill. The inputting and recording of the registered data can be in a computerized system with the individual identity clearly marked against his/her sexual health status. Online information can be accessed through any multimedia option including interactive voice based sexual health status transmission.

It is thus possible by way of the system and method to serve the present day needs for an online and instant enquiry on an individual's sexual health status to safeguard against unknown dangers of inheriting further transmitted sexually transmitted diseases.

### BRIEF DESCRIPTION OF THE ACCOMPANYING DRAWINGS

This and other features and advantages of the system and method of the present invention may be better and completely known by referring and following detail description of a presently preferred exemplary embodiment in conjunction with the drawing wherein:

FIG. 1 is a flowchart of the system, identifying the steps covered, from the consultation made by the user (intended member), through the screening done for testing the individuals' sex status and mode of tests followed, examination by the professionals of the areas of health and those related thereto for the diagnosis of the case, to the final findings on the health status of such intended member;

FIG. 2 is illustrative schematic view of the sequence of events to carry out the interactive information generation by a member using the system and following the present method.

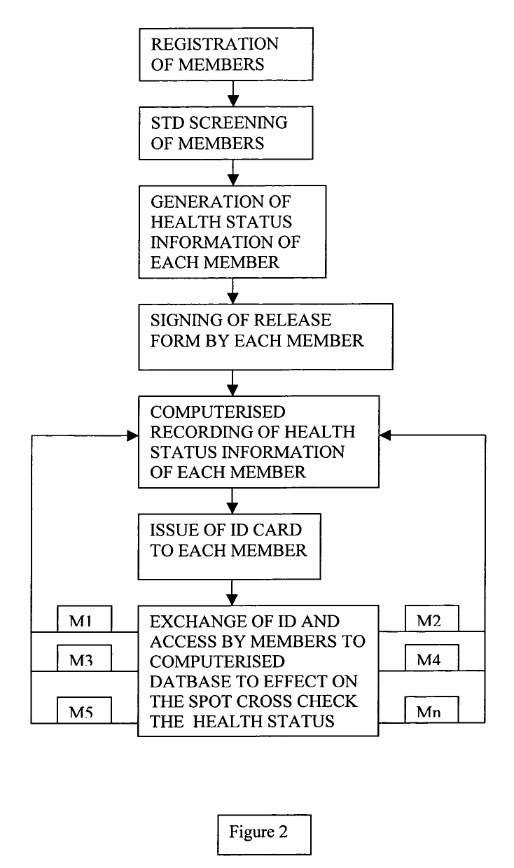

### DETAILED DESCRIPTION OF THE PREFERED EMBODIMENT

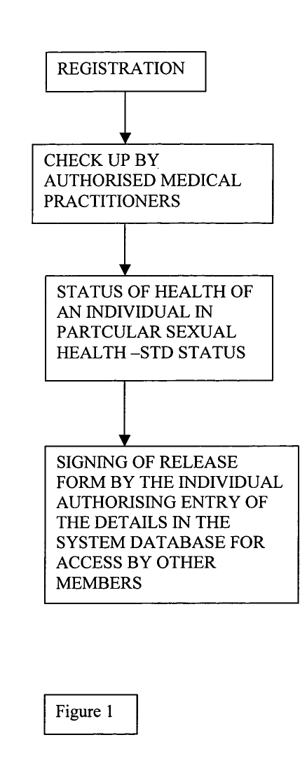

As would be apparent from FIG. 1 illustrating the sequence of events in the developing of the system and its methods of used for confirming the sexual health status of an individual, the same involves the following basic steps for sexually transmitted diseases prevention services involving the present invention.

Any person desiring the member or using the system are required to undertake a full STD screening at a medical center after paying a registration fee and is required to sign a release from authorizing the system provider to put the information in the system. The information from the health status includes the date of test and period of validity, which are fed into computerized recording and storing system.

After the details are recorded the registered individual is given an ID card with a personal code. All persons thus registered having the ID card can lead an STD free life.

Any member can thus freely meet another member by way for exchanging their respective ID and related sexual health status information. For the purpose any member can call the system/service provider for a flat fee to get connected with the automated service. The member will be required to enter their ID to confirm then as a registered member and they after the member is required to enter the ID of the person whose sexual health status is required to be confirmed. Once this is completed, the automated service will generate the last date the member being enquired got tested and whether the test results were positive or negative for any STD's.

It is thus possible by way of the present invention to provide for system and method of effective utilization of the sexual health status of individuals and thereby provide for safe guarding the interest of persons free of such diseases to continue to live a safe and healthy life. The system and the method would enable making people practically determined and more conscious about the needs and purposes of checking of sexual health status without the complexity of delay and time involved in carrying out instant tests. The system and the method would enable regular and systemized maintenance of health status of individuals so that the society of large can benefit by way of having a non-public yet confirmatory source for confirming individual's sexual health status.

1. An interactive system for confirming the sexual health status of an individual comprising:
means for registering and storing an individual's sexual health status along with his/her personal identity;
means for online access to an individual's sexual health status based on said individual's personal identity to ascertain whether the particular individual is STD free or not.

2. An interactive system according to claim 1, wherein said personal identity is through individual's ID card and a personal pass code.

3. An interactive system according to claim 1, wherein said means for registering and storing an individual's sexual health status is a computerized registration system.

4. An interactive system according to claim 1, comprising:
database on health status of individuals;
a multimedia means for accessing the information concerning an individual's sexual health.

5. An interactive system according to claim 4, comprising interactive voice based sexual health status transmission.

6. An interactive system according to 5, comprising means for authorized verifiable update of sexual health status after a preselected period.

7. A method for on-line and instant verification for an individual's sexual health status comprising:
(i) inputting and recording after proper registration procedures the computerized sexual health status of an individual;
(ii) providing the individuals whose sexual records are thus recorded with a personal identification; and
(iii) providing on-line access to interested persons to the information recorded on an individual's sexual health status on proper submission of personal identification no. of the concerned individual whose sexual status is being enquired for said on-line verification of the individual's sexual health status.

8. A method for on-line verification for an individual's sexual health status according to claim 7, wherein the personal identification used is based on an ID Card and personal pass code issued to an individual whose sexual health status is recorded.

9. A method for on-line verification for an individual's sexual health status according to claim 7, wherein said on-line access is allowed subject to proper identification and pass code and payment of requisite fees.

10. A method for on-line verification for an individual's sexual health status according to claim 7, wherein the sexual health status issued is accompanied with the date of last check-up and period of validity of the individual's recorded sexual health status.

11. A method for on-line verification for an individual's sexual health status according to claim 7, wherein a person wanting to enter his/her sexual health status has to undertake full STD screening and then registered.

12. A method for on-line verification for an individual's sexual health status according to claim 7, wherein the registration is subject to the individual's offer to release the sexual health status information in said computerized system.
